(19) United States
(12) Patent Application Publication
(10) Pub. No.: US 2004/0185796 A1
(43) Pub. Date: Sep. 23, 2004

(54) Method and device for the wireless transmission of voice data

(76) Inventors: Anton Kruk, Hamminkeln (DE); Andreas Muller, Rees (DE); Burkhard Pauli, Dorsten (DE); Peter Schliwa, Hamminkeln (DE)

Correspondence Address: BELL, BOYD & LLOYD, LLC, P. O. BOX 1135, CHICAGO, IL, 60690-1135, US

(21) Appl. No.: 10/483,867

(22) PCT Filed: Jul. 4, 2002
(86) PCT No.: PCT/DE02/02454

(30) Foreign Application Priority Data
Jul. 10, 2001 (EP) 101 33 518.0

(51) Int. Cl. H04B 1/40

(52) U.S. Cl. 455/84

(57) ABSTRACT

A method and device are provided for the wireless transmission of voice data between at least two terminals, whereby the voice data is transmitted in data packets in predefined time frames with multiple redundancies and in time intervals at different frequencies. The present invention is characterized in that the transmission takes place at different frequencies, at least with regard to a pair of redundant data records.

The invention relates to a method and a device for the wireless transmission of voice data between two terminals, the voice data being transmitted in data packets in predefined data frames with multiple redundancy and in time intervals at alternating frequencies.

Such a method is generally known by the name “Bluetooth” as a standard for the radio communication at short ranges between terminals. Terminals to be considered are, for example, mobiles, notebooks, organizers, PDAs or also personal computers with peripheral devices. In this data transmission, a multiple, if possible triple, redundancy is performed during the data transmission in accordance with the standardized Bluetooth protocol. During this process, each individual bit is transmitted three times in direct succession for generating the redundancy, so that the receiver, in the case of possible disturbances, in each case accepts the more frequently transmitted bit in a triplet of identical bits as the more probable one.

One problem with this manner of transmission can lie in the fact, however, that in the hops between frequencies existing in the Bluetooth standard, relatively noisy frequencies are also sometimes used for data transmission, when all data which were transmitted in this frequency band cannot be easily recognized even if they had multiple redundancy.

It is, therefore, the object of the invention to find a method according to the preamble of claim 1 which creates greater reliability with the same redundancy of the data transmitted.

The object of the present invention is achieved by the features of claim 1.

The inventors have recognized that it is more advantageous to transmit the redundantly transmitted bits simultaneously not only at a single frequency and within a very short time but to distribute these redundant bits to a number of frequencies and over a relatively long time so that the probability of disturbance relating to all redundant bits of a particular information item is greatly reduced.

In a method for the wireless transmission of voice data between at least two terminals, in which the voice data are transmitted in data packets in predefined data frames with multiple redundancy and in time intervals at alternating frequencies, a transmission takes place at different frequencies at least with respect to a redundant pair of data records.

A further advantageous improvement of the method according to the invention can result from the fact that the quality of the data transmission is checked and the number n of redundant data packets is a function of the quality of the data transmission.

In this arrangement, the quality of the data transmission can be determined continuously before the beginning of the transmission of the data packets or also during the current data transmission. The number n of redundant data packets can then be adaptively adapted so that transmission takes place with higher redundancy as soon as poor data quality is measured, and conversely. In extreme cases, the transmission of redundant data packets can even be dispensed with in the case of a best data quality whereas a very high redundancy is set with a poor data quality which, however, has a disadvantageous effect on the data transfer rate.

This method is preferably used in the so-called Bluetooth standard.

Since, due to this method, the redundancy is divided into at least two different, preferably three different, frequencies and this division also takes place over a relatively long period of time, the probability of disturbance due to external influences is reduced compared with the known standard in which the redundancy is generated by a number of identical bits transmitted in direct succession.

Advantageously, n, preferably three, redundant data packets, divided into n successively selected frequencies, can be transmitted in this arrangement, in each case n generations of data packets being transmitted in one frequency, which are preferably arranged in accordance with their age.

In accordance with the basic concept of the invention, a circuit arrangement for carrying out the method presented above and also a transceiver device, preferably of a Bluetooth device, with a processor and program code means for carrying out the abovementioned method is also proposed.

Other advantageous embodiments can be found in the subclaims and the subsequent description of a preferred exemplary embodiment.

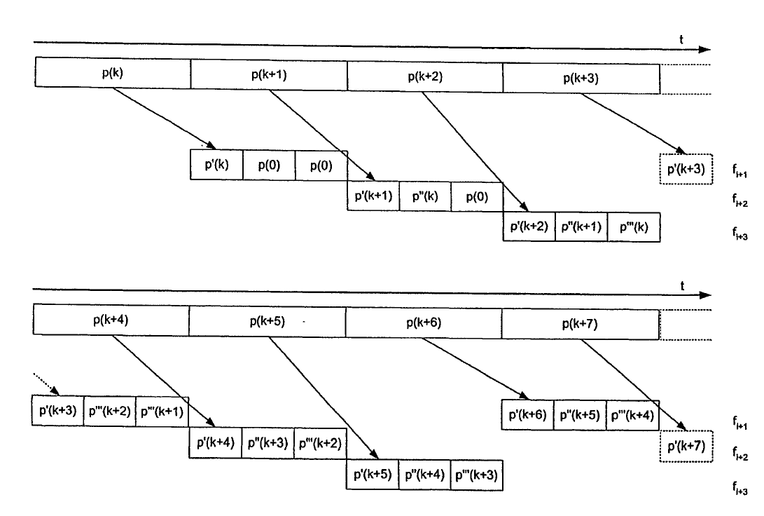

FIG. 1 shows a diagrammatical presentation of the variation of a voice data stream with time along the time axis t. For space reasons, this successive time axis t has been represented in two lines. Below the time axis t, the digitized data of a voice stream are located which are divided into packets p in successive packets p (k+x).

According to the invention, each packet p(k+x) is compressed to a packet p′(k+x), in such a manner that, at the most, one third of the transmitted time is used up during the actual data transmission. In this manner, at least three times the volume of data can now be transmitted during the time of the data stream so that each individual data packet—as shown—is transmitted once in a shortened manner in a first frequency fᵢ₊₁. Since, at the beginning of the transmission, the two following data packets p(0) do not yet contain any information, they can be filled, for example, with any data or so-called mute patterns. During the transition to the next frequency, the data packets shift to the right by one data record so that the next data packet p(k+1) can be placed into the triplet of the data packet of the next frequency f₂. In this manner, lastly, three generations of compressed data packets p′, p″ and p′″, which are to be allocated to three successive conventional packets, are transmitted on each frequency. The redundancy of the data is thus divided, on the one hand, over three frequencies fᵢ₊₁, fᵢ₊₂ and fᵢ₊₃ and, on the other hand, is also distributed in time over a greater period. This results in a much lower susceptibility to disturbances and this method can be preferably used in the Bluetooth standard.

At the end of a voice transmission, this method can be simply discontinued, the last data packet then being sent only once and the penultimate one being sent only twice.

With respect to the described example, it can be additionally noted that the said frequencies fᵢ₊₁ to fᵢ₊₃, naturally, are not absolute frequencies and, naturally, more than the specified three frequencies can also be used from an available pool of frequencies. The order of frequencies used can be selected arbitrarily.

Naturally, the above-mentioned features of the invention can be used not only in the combination specified in each case, but also in other combinations or by themselves without departing from the context of the invention.

1. A method for the wireless transmission of voice data between at least two terminals, the voice data being transmitted in data packets in predefined data frames with multiple redundancy and in time intervals at alternating frequencies, characterized in that
a) the transmission takes place on different frequencies at least with respect to a redundant pair of data records,
b) in that n data packets are transmitted at one frequency.

2. The method as claimed in claim 1, characterized in that the data are transmitted with n-tuple redundancy, where n≧2, preferably n=3.

3. The method as claimed in one of the preceding claims 1 to 2, characterized in that n redundant data packets are transmitted divided into n successively selected frequencies.

4. The method as claimed in one of the preceding claims 1 to 4, characterized in that in each case n generations of data packets preferably arranged in accordance with their age are transmitted in one frequency.

5. The method as claimed in one of the preceding claims 1 to 5, characterized in that the quality of the data transmission is checked and the number n of redundant data packets is a function of the quality of the data transmission.

6. The method as claimed in the preceding claim 6, characterized in that the quality of the data transmission is determined before the beginning of the transmission of the data packets.

7. The method as claimed in one of the preceding claims 6 to 7, characterized in that the quality of the data transmission is continuously determined during the data transmission and the number n of redundant data packets changes adaptively.

8. A circuit arrangement with means for carrying out the method as claimed in one of claims 1 to 5.

9. A transceiver device, preferably of a Bluetooth device, with a processor and program code means for carrying out the method as claimed in one of claims 1 to 5.
